(19) United States
(12) Patent Application Publication
(10) Pub. No.: US 2009/0309977 A1
(43) Pub. Date: Dec. 17, 2009

(54) BENCHMARKING AND CALIBRATING VIDEO QUALITY ASSESSMENT TOOLS

(75) Inventors: Lutfi Murat Gevrekci, Peachtree City, GA (US); Regis J. Crinon, Camas, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/138,405

(22) Filed: Jun. 12, 2008

(51) Int. Cl. H04N 17/00

(52) U.S. Cl. 348/180; 348/E17.001

(57) ABSTRACT

Architecture for emulating a wide variety of possible degradations in a video signal and applying the degradations to video quality assessment (VQA) tools and quality of assessment (QoA) systems to test that performance consistently responds to all possible degradations. Methods are provided for producing deterministic impairments to the video signal, where the impairments mimic the effect of video compression or lossy delivery networks. The methods can be integrated into a software and/or hardware products built to exercise and quantify the performance of an active VQA systems and integrated to calibrate passive QoA systems. The methods can be used to produce a reference content database for further use in benchmarking QoA systems and a database that cross correlates with representative mean opinion scores (MOS) collected from subjective testing.

### BACKGROUND

Video quality delivered to an end user in a video conference gets degraded due to multiple sources. Degradations can stem from the compression and decompression applied to raw video and from the transmission process through a communication network such as an enterprise IP network.

Full reference (FR) video quality assessment (VQA) tools became increasingly important to monitor the quality of IPTV (IP television) and videoconferencing applications, for example. Performance of VQA tools depends on the visual quality of the source (e.g., webcam). FR VQA tools compare degraded video with the raw captured video to produce a single mean opinion score (MOS). In other words, FR VQA tools basically measure the correlation between degraded and the reference video (raw camera output). A low quality camera might produce high results if degraded video highly correlates with reference video of the same webcam. This aspect necessitates considering the source dependent degradations as well as network and codec artifacts. Today, there is no recognized benchmarking methodology and software for VQA tools.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes a program that emulates a wide variety of possible degradations in a video signal such as during video conferencing, for example. Accordingly, video quality assessment (VQA) tool performance can be benchmarked to ensure the tool consistently responds to all possible degradations.

The architecture includes methods for producing deterministic impairments to the video signal, where the impairments mimic the effect of video compression or lossy delivery networks. The methods can be integrated into a software and/or hardware products built to exercise and quantify the performance of an active (full reference) VQA system. The methods can be used to produce a reference content database for further use in benchmarking quality of assessment (QoA) systems. Additionally, the methods can be integrated to calibrate a passive (no reference) QoA system.

The architecture further provides the ability to perform a non-realtime calibration of a passive QoA system used in a RTC (realtime communication) platform. A similar ability is provided in realtime (during a Video over IP call or conference) either in a periodic fashion or at predefined instants. Ultimately, a database can be generated that cross correlates with representative mean opinion scores (MOS) collected from subjective testing.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented test and calibration system

FIG. 2 illustrates an alternative test and calibration system.

FIG. 3 illustrates a video quality assessment framework

FIG. 4 illustrates an exemplary user interface for presenting and selecting degradation sources.

FIG. 5 illustrates exemplary binary quantization table of blocks for emulated compression impairments.

FIG. 6 illustrates a technique for providing video impairments related to luminance quantization.

FIG. 7 illustrates quantization emulation for chrominance.

FIG. 8 illustrates a computer-implemented test method.

FIG. 9 illustrates further exemplary aspects in the computer-implemented diagnostic method.

FIG. 10 illustrates block diagram of a computing system operable to execute emulation and testing in accordance with the disclosed architecture.

### DETAILED DESCRIPTION

The disclosed architecture provides for emulating a wide variety of possible degradations in a video signal and applying the degradations to video quality assessment (VQA) tools and quality of assessment (QoA) systems to test that performance consistently responds to all possible degradations. Methods are provided for producing deterministic impairments to the video signal, where the impairments mimic the effect of video compression or lossy delivery networks. The methods can be integrated into a software and/or hardware products built to exercise and quantify the performance of an active VQA systems and integrated to calibrate passive QoA systems. The methods can be used to produce a reference content database for further use in benchmarking QoA systems and a database that cross correlates with representative mean opinion scores (MOS) collected from subjective testing.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and cover all modifications, equivalents, and alternatives falling within the spirit and scope of the claimed subject matter.

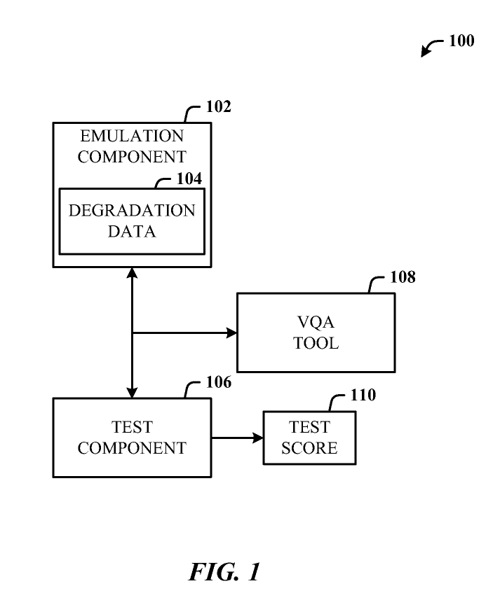

FIG. 1 illustrates a computer-implemented test and calibration system 100. The system 100 includes an emulation component 102 for generating degradation data 104 that emulates degradation of a video signal which occurs due to video signal processing and video signal distribution, and a test component 106 for applying the degradation data 104 to a VQA tool 108 and generating a test score 110 that quantifies performance of the VQA tool 108.

The emulation component 102 further generates source data as part of the degradation data 104. The source data emulates degradation of the video signal introduced by a source (e.g., camera, webcam, conference camera, etc.) of the video signal. The test component 106 applies the degradation data 104 to generate the test score 110 that quantifies the performance of the VQA tool 108 related to the source, the video signal processing, and the video signal distribution. For example, the degradation data 104 generated by the emulation component 102 emulates distribution congestion of an IP network. The degradation data 104 generated by the emulation component 102 can also emulate noise, blur, block-based compression artifacts, video frame/field drop/freeze, contour artifacts due to subsampling of luma and chroma components, frame rate change, and jitter. The test component 106 quantifies the performance of the VQA tool 108, which is an active VQA tool. The test score 110 can be a MOS.

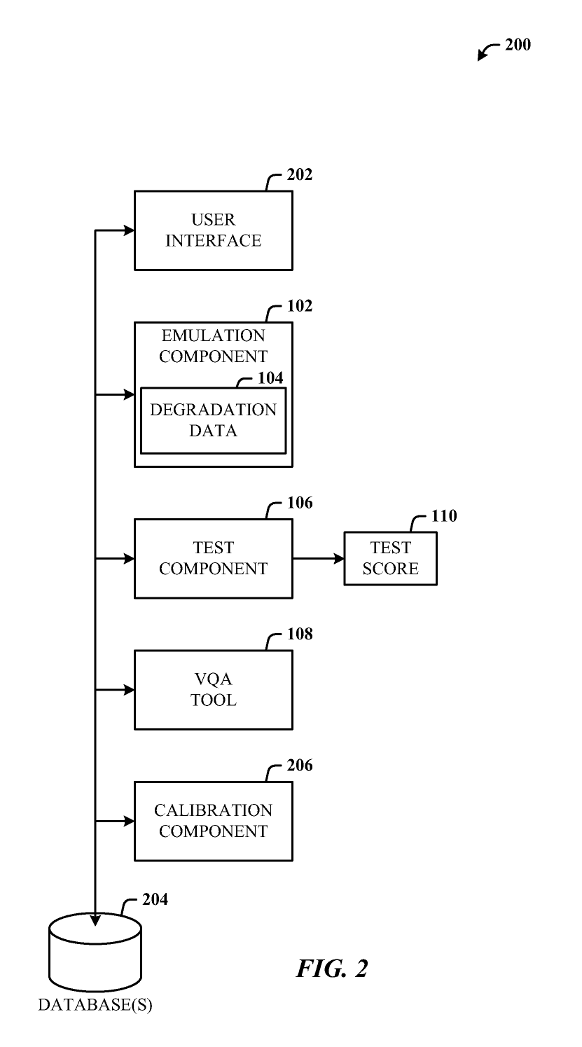

FIG. 2 illustrates an alternative test and calibration system 200. The system 200 includes the emulation component 102 for generating the degradation data 104 that emulates degradation of a video signal which occurs due to video signal processing and video signal distribution, and the test component 106 for applying the degradation data 104 to the VQA tool 108 and generating the test score 110 that quantifies performance of the VQA tool 108.

The system 200 further comprises a user interface (UI) 202 for at least presenting types of the degradation data 104, one or more of the types which can be selected for application to the VQA tool 108 by the test component 106. In other words, the user can select a single type of degradation (e.g., noise) to apply to the VQA tool 108, or combinations of the types to be applied to the VQA tool 108. The UI 202 can also be employed for managing other aspects of the test, such as selecting the video source, analyzing the test score(s), and accessing one or more databases 204 for test setup information, reference content, etc.

For example, if two degradation types are selected, the test component 106 can then run a single test using both degradation types to output a single test score, run two separate tests where each test considers a degradation type and each test outputs a test score, or both the combined test and the sequential tests. The test score 110 (e.g., MOS) then represents performance of the VQA tool 108 based on the single degradation type or the multiple degradation types.

The system 200 can further comprise the one or more databases 204 that store the degradation data for access in benchmarking a quality of assessment system, and store test results that cross-correlate with representative mean opinion scores obtained from subjective testing of the VQA tool.

The system 200 can also include a calibration component 206 for calibrating the VQA tool 108 based on the degradation data 104 and the test score 110. The emulation component 102, test component 106, and calibration component 206 can be embodied as part of a video conferencing system. Additionally, the calibration component 206 can be used to calibrate a passive quality assessment tool, where the passive quality assessment tool employed in a realtime communication platform.

For example, in one implementation, a test and calibration system 200 can employ the user interface 202 for presenting one or more types of video impairments for selection as the degradation data 104. The video impairments represent video signal degradation that occurs due to a video codec and to video signal transmission. The system 200 can further employ the emulation component 102 for generating the degradation data 104 defined by the selected one or more types of video impairments, and the test component 106 for applying the degradation data to the VQA tool 108 and generating the test score 110 that quantifies performance of the VQA tool 108.

The calibration component 206 can be employed for performing non-realtime calibration of a passive quality of assessment system or realtime calibration according to predetermined time data. The database(s) 204 include a database that stores the degradation data for access in benchmarking a quality of assessment system, and a database that stores test results that cross-correlate with representative mean opinion scores obtained from subjective testing of the VQA tool 108.

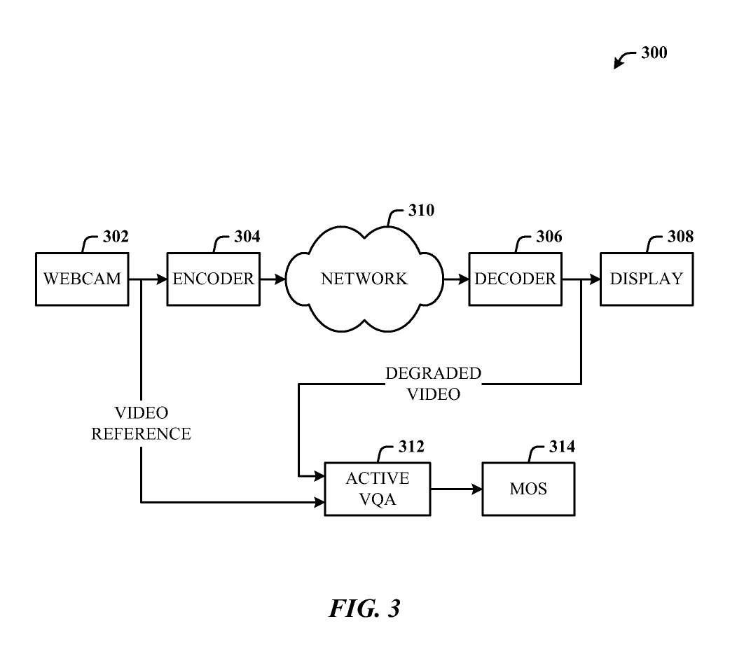

FIG. 3 illustrates a VQA framework 300. The performance of VQA tools depends on the visual quality of the source (e.g., a webcam, camera, etc.). Here, a webcam 302 is the source of the video signal. The video signal is processed through a codec that comprises a video encoder 304 and a video decoder 306. Thus, the visual quality can include the effects of the codec. Additionally, the video signal is transmitted from the webcam 302 to a display 308 via a communications media that can include a network 310, network switches, and so on.

A full reference (FR) VQA tool 312 basically measures the correlation between degraded video as obtained at the output of the decoder 306 and the reference video (raw webcam output) at the output of the webcam 302, and outputs a MOS 314 (the test score 110). A low quality camera may produce high results if degraded video highly correlates with reference video of the same webcam. This aspect can necessitate considering the source dependent degradations as well as network and codec artifacts. Thus, the overall visual quality can be represented as the function of following quality parameters

Overall Quality=F(Q_{source}, Q_{codec}, Qₜᵣₐₙₛₘᵢₛₛᵢₒₙ)

Note that VQA tools can provide MOS results that consider only Q_{source} and Qₜᵣₐₙₛₘᵢₛₛᵢₒₙ as illustrated in FIG. 3. When evaluating webcam quality, for example, the webcam as the source can be important to consider source (webcam) dependent degradations. Although only codec and transmission quality are described herein, it is to be understood that source quality (Q_{source}) can also be considered as part of the framework in order to provide a more inclusive representation of overall quality. In other words, the approach can be extended to consider the impact that the webcam 302 has on the video quality.

Video impairments are highly dependent on the network conditions and selected codecs. The possible degradations with associated sources will now be described before further describing the emulation of these degradations.

Congestion is observed frequently in a network due to heavy network traffic. A server handles congestion by rate adaptation mechanisms. A video server has two possible ways of video rate adaption. A first solution is to switch from a video stream to a lower data rate stream in case multiple video streams are available. However, data rate reduction results in noticeable video quality degradation although flow of the stream is not interrupted. A second solution is to skip key frames (I-frames) in case the encoder load becomes excessive. The suppression of key frames creates jerkiness and frame freeze effects on the receiver, since the last received frame is duplicated. Frame freeze can also occur due to frame drop. Effective frame rate is also modified in case of packet loss or frame freeze/drop.

Compression removes redundant information to perform efficient transmission. Compression can be achieved using block-based processing techniques. Block-based compression is applied using interframe or intraframe mode in H.26x. Compression introduces several artifacts such as blockiness at block borders and blurring effects within blocks. Noise is also a consequence of compression. Compression schemes mostly introduce content dependent mosquito noise which occurs near edges of the images. Block-based image compression uses discrete cosine transform (DCT) on each block (e.g., 8×8 pixel blocks). DCT coefficients are quantized before variable length coded. Quantization brings contouring artifacts depending on the quantization scale being used.

Possible degradations can be enumerated as noise (e.g., Gaussian, mosquito, etc.), blur (e.g., Gaussian), blockiness due to DCT compression, video frame or fields drop/freeze, contour artifacts due to quantization of luma and chroma components, effective frame rate change, and jitter.

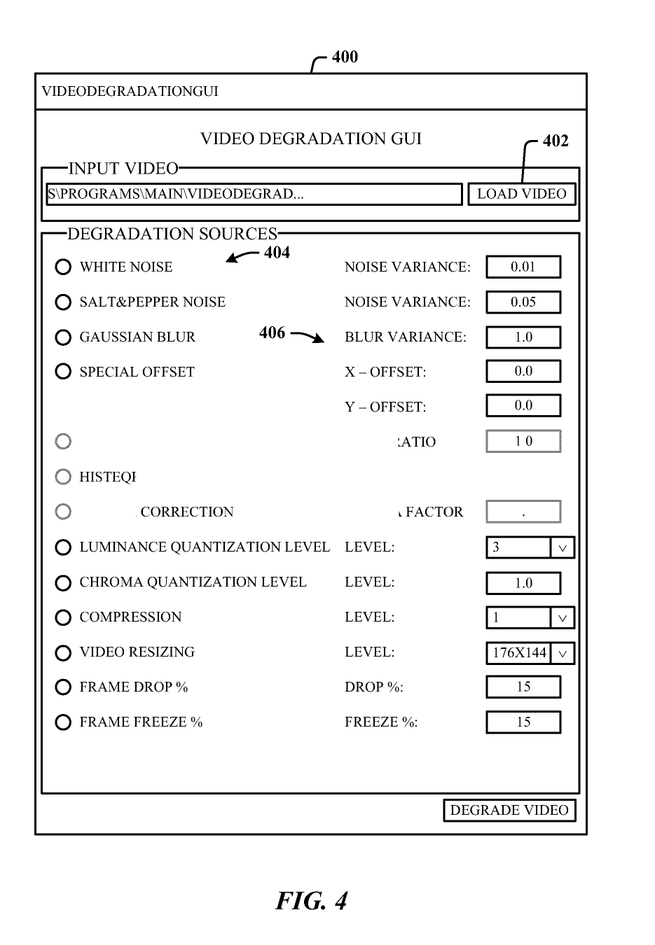

FIG. 4 illustrates an exemplary UI 400 for presenting and selecting degradation sources. The UI 400 provides a loading means 402 for loading sample video for loading and playing through the codec and transmission network. The UI 400 also presents a set of degradation sources 404 that can be individually selected for application to the video signal. The sources 404 include white noise (Gaussian), salt and pepper noise, blur, offset, zoom, gamma correction, luminance and chrominance quantization, compression, video resizing, frame drop percentage, frame freeze percentage, for example. It is to be understood that other impairments can be employed as desired.

Along with each of the degradation sources 404 are settings 406 that a user can manipulate to provide more granular control over the particular source. For example, the white noise impairment can be provided with three levels of noise variance: 0.01, 0.001, and 0.0001. The salt and pepper noise can be provided with three levels of noise variance: 0.01, 0.03, and 0.05. The Gaussian blur can be provided with two sets: 0.3/0.5 and 1.3/1.5. Compression artifacts can be emulated using seven levels, which will be described in more detail below, as one example as to how deterministic impairments can be employed. Variable bit rate compression can be provided in four levels, for example. Frame drop can be provided in four levels of 15, 30, 45, and 60 percent, for example. Frame freeze can be provided in five levels of 15, 30, 45, 60, and 75 percent, for example. Video resizing can be presented in many desired pixel resolutions, for example, 176×144.

White noise is created with zero mean, and variance (noise power) can be specified by the user. Noise variance and peak signal noise ratio (PSNR) values can range from 25 dB to 47 dB. For example, a variance setting of 0.01 can result in an average PSNR of 26.69 dB. PSNR in a video conference generally changes in the range of 25 dB and 47 dB, where 45 dB indicates unnoticeable noise by the human visual system. A VQA tool can assign MOS 1 to PSNR values less than or equal to 25 dB. A MOS 5 sore can be given to PSNR values higher than 45 dB. MOS scores in-between change linearly according to PSNR values. This same method can be applied to the luma fields, chroma fields, or both luma and chroma fields of the video frame/field.

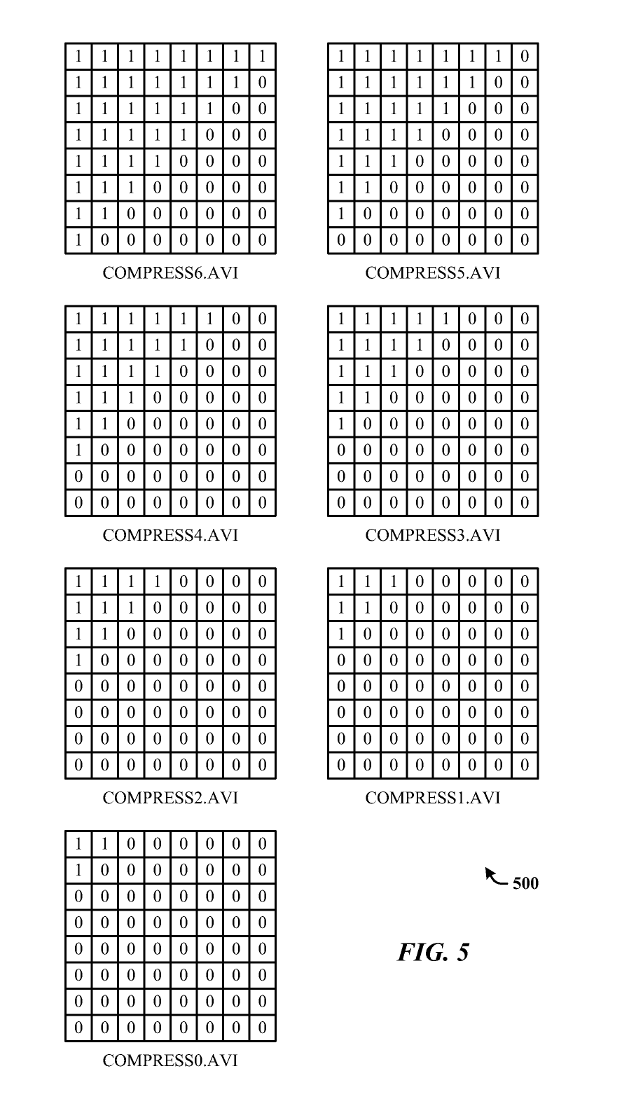

FIG. 5 illustrates exemplary binary quantization table of blocks 500 for emulated compression impairments. Intraframe image compression is provided to emulate blocking artifacts. An image is first divided into 8×8 blocks and the DCT of each block is computed independently. The DCT coefficients are quantized before variable length encoding using zigzag manner scanning. Quantization causes some portion of DCT coefficients getting discarded. Quantization scale determines what portion of the coefficients will be discarded, resulting in a rate control. Quantization scale is generally adjusted in a system to keep the encoder buffer at the middle point. Certain portions of the DCT coefficients can be thrown out of the sixty-four DCT coefficients to simulate this behavior.

The UI 400 of FIG. 4 allows for retaining the following number of DCT coefficients {3,6,10,15,21,28,36} out of the sixty-four DCT coefficients. Note that blocking artifacts will be less as we use more number of DCT coefficients. The blocks 500 and associated DCT masks with retained coefficients are shown in FIG. 5.

In one implementation, the system can apply sixty-four steps. Here, however, seven coefficients are used and the processing is performed in a diagonal fashion because this effectively is equivalent to removing the same amount of horizontal and vertical detail currently in the video. The different levels can also be invoked manually, if desired.

This method can also be applied to each field of a YUV or RGB or any other representation of a video frame/field.

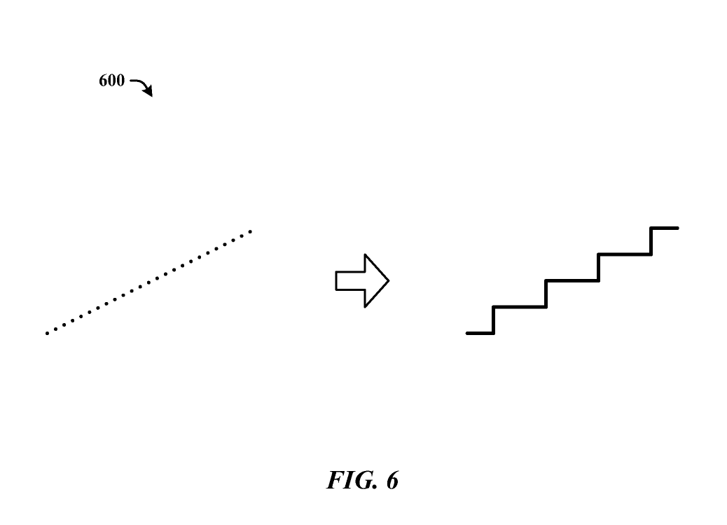

FIG. 6 illustrates a technique for providing video impairments related to luminance quantization. Contouring artifacts are observed in videoconferencing in cases of high level of quantization apart from compression. A user can select a quantization scale for intensity mapping to mimic the contouring artifacts. For example, for a quantization level of 3, intensity mapping can be as the following:

{0,1,2}→1

{2,3,4}→3

{4,5,6}→5

. . .

{253,254,255}→254

This mapping 600 can be illustrated as in FIG. 6. The UI 400 of FIG. 4 allows quantization levels of {3, 5, 7, 9}, which are sufficiently wide to simulate possible contouring artifacts.

In other words the VQA tool is tested as to the sensitivity of the tool to banding artifacts. Emulation is provided by the mapping of multiple values to one value to artificially induce these quantizations in the video. Thus, a method is provided to vary the degree of banding by managing how many values get mapped to one value. More severe banding in the video results can be obtained by mapping more values to a single target value. The more values that are mapped to the same value, the more difficult the quantization is, the coarser the quantization is and the more banding artifacts that can be introduced into the video. The VQA tool is exercised on various levels of banding and the consistency of the MOS scores at the output can be observed and analyzed when sweeping across these various combinations.

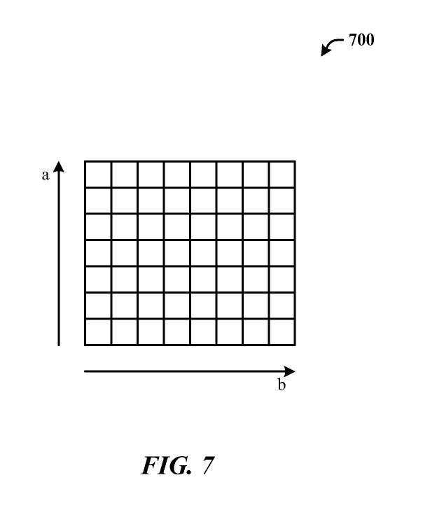

FIG. 7 illustrates quantization emulation for chrominance. Chroma is a two dimensional (a,b) color component 700 which uses vector quantization. Each chroma component can take 256 different values, yielding 65536 different values. The user can choose quantization levels in the range of [0, 65535]. Note that the quantization level between n2 and (n+1)2 yields same result, since chroma is tessellated using square blocks as shown below.

The same methodology as described above can be applied separately or in combination for the black field and white field, meaning that control of the quantization can be independently on the first chroma field (a) and the second chroma field (b). However, in one embodiment, the quantization of the two chroma fields can be controlled concurrently, as shown in the color component 700.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

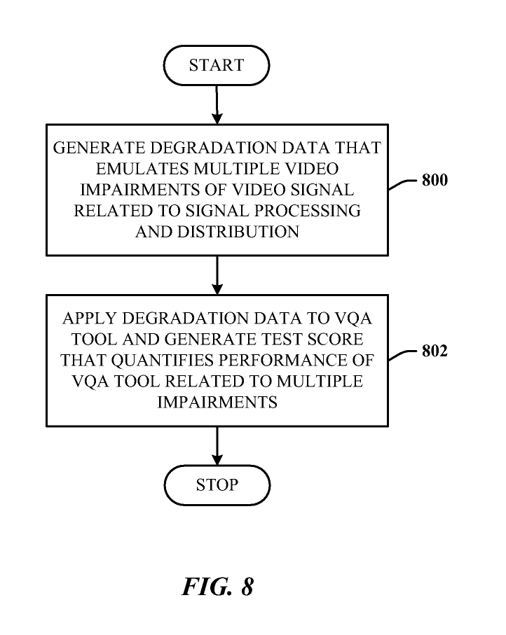

FIG. 8 illustrates a computer-implemented test method. At 800, degradation data is generated that emulates multiple video impairments of a video signal that occur due to video signal processing and video signal distribution. At 802, the degradation data is applied to a VQA tool and generating a test score that quantifies performance of the VQA tool related to the multiple impairments. The video impairments are deterministic impairments that mimic effects of video compression and lossy delivery networks.

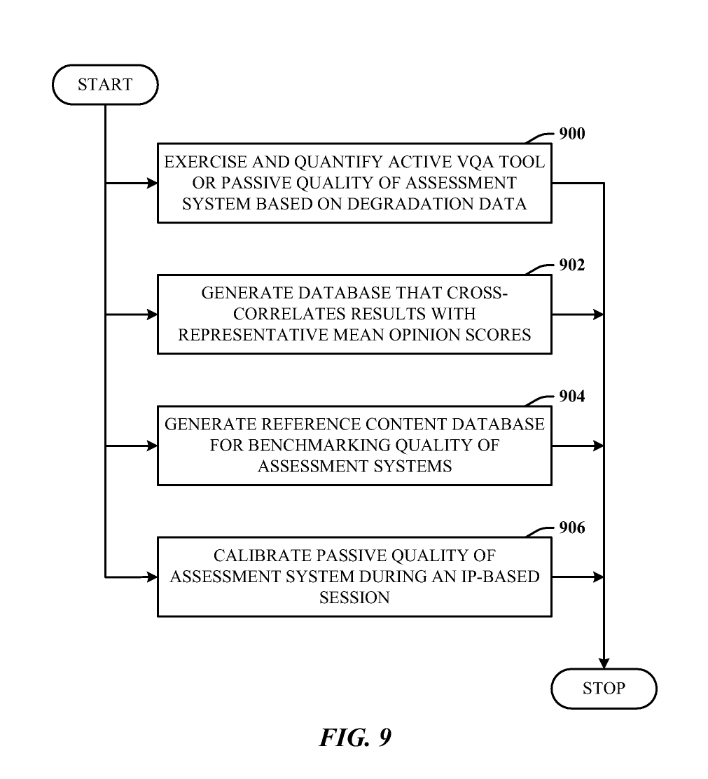

FIG. 9 illustrates further exemplary aspects in the computer-implemented diagnostic method. At 900, an active VQA tool or a passive quality of assessment system can be exercised and quantified based on the degradation data. At 902, a database can be generated that cross-correlates results with representative mean opinion scores. At 904, a reference content database can be generated for benchmarking quality of assessment systems. At 906, a passive quality of assessment system can be calibrated during an IP-based session.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

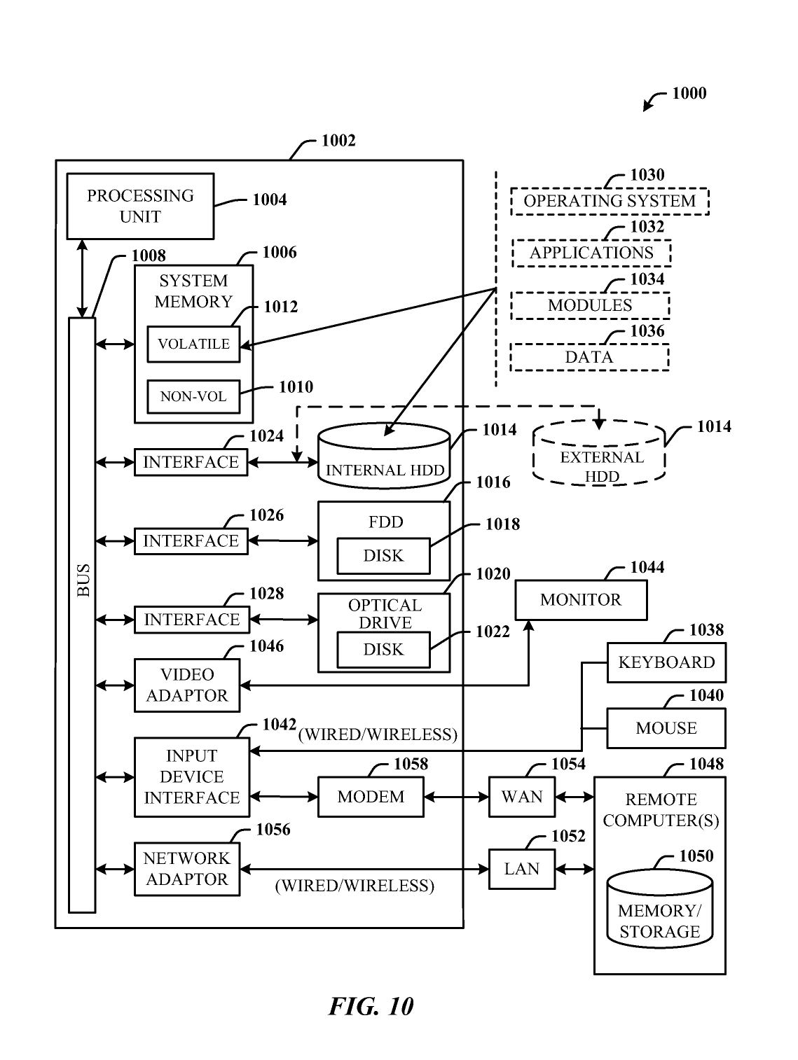

Referring now to FIG. 10, there is illustrated a block diagram of a computing system 1000 operable to execute emulation and testing in accordance with the disclosed architecture. In order to provide additional context for various aspects thereof, FIG. 10 and the following discussion are intended to provide a brief, general description of a suitable computing system 1000 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary computing system 1000 for implementing various aspects includes a computer 1002 having a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 can include non-volatile memory (NON-VOL) 1010 and/or volatile memory 1012 (e.g., random access memory (RAM)). A basic input/output system (BIOS) can be stored in the non-volatile memory 1010 (e.g., ROM, EPROM, EEPROM, etc.), which BIOS are the basic routines that help to transfer information between elements within the computer 1002, such as during start-up. The volatile memory 1012 can also include a high-speed RAM such as static RAM for caching data.

The computer 1002 further includes an internal hard disk drive (HDD) 1014 (e.g., EIDE, SATA), which internal HDD 1014 may also be configured for external use in a suitable chassis, a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as a DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1012, including an operating system 1030, one or more application programs 1032, other program modules 1034, and program data 1036. The one or more application programs 1032, other program modules 1034, and program data 1036 can include the emulation component 102, the degradation data 104, test component 106, VQA tool 108, test score 110, the UI 202, database(s) 204, calibration component 206, active VQA tool 312 and MOS 314, UI 400, and compression, luma and chroma quantization methods of FIGS. 5-7, for example. Additionally, the methods of FIGS. 8 and 9 can be applied.

All or portions of the operating system, applications, modules, and/or data can also be cached in the volatile memory 1012. It is to be appreciated that the disclosed architecture can be implemented with various commercially available operating systems or combinations of operating systems.

A user can enter commands and information into the computer 1002 through one or more wire/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, etc.

A monitor 1044 or other type of display device is also connected to the system bus 1008 via an interface, such as a video adaptor 1046. In addition to the monitor 1044, a computer typically includes other peripheral output devices (not shown), such as speakers, printers, etc.

The computer 1002 may operate in a networked environment using logical connections via wire and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented test and calibration system, comprising:
an emulation component for generating degradation data that emulates degradation of a video signal which occurs due to video signal processing and video signal distribution; and
a test component for applying the degradation data to a video quality assessment (VQA) tool and generating a test score that quantifies performance of the VQA tool.

2. The system of claim 1, wherein the emulation component further generates source data as part of the degradation data, the source data emulates degradation of the video signal introduced by a source of the video signal, and the test component applies the degradation data to generate the test score that quantifies the performance of the VQA tool related to the source, the video signal processing, and the video signal distribution.

3. The system of claim 1, wherein the degradation data generated by the emulation component emulates distribution congestion of an IP network.

4. The system of claim 1, wherein the degradation data generated by the emulation component emulates noise, blur, block-based compression artifacts, video frame/field drop/freeze, contour artifacts due to luma and chroma components, frame rate change, and jitter.

5. The system of claim 1, further comprising a calibration component for calibrating the VQA tool based on the degradation data and the test score.

6. The system of claim 5, wherein the emulation component, test component, and calibration component are employed in a video conferencing system.

7. The system of claim 5, wherein the calibration component calibrates a passive quality assessment tool, the passive quality assessment tool employed in a realtime communication platform.

8. The system of claim 1, wherein the test component quantifies the performance of the VQA tool, which is an active VQA tool.

9. The system of claim 1, further comprising a database that stores the degradation data for access in benchmarking a quality of assessment system, and test results that cross-correlate with representative mean opinion scores obtained from subjective testing of the VQA tool.

10. The system of claim 1, further comprising a user interface for presenting types of degradation data, one or more of the types which can be selected for application to the VQA tool by the test component.

11. A computer-implemented test and calibration system, comprising:
a user interface for presenting one or more types of video impairments for selection as degradation data, the video impairments representative of video signal degradation that occurs due to a video codec and to video signal transmission;
an emulation component for generating the degradation data defined by the selected one or more types of video impairments; and
a test component for applying the degradation data to a VQA tool and generating a test score that quantifies performance of the VQA tool.

12. The system of claim 11, further comprising a calibration component for performing non-realtime calibration of a passive quality of assessment system or realtime calibration according to predetermined time data.

13. The system of claim 11, further comprising a database that stores the degradation data for access in benchmarking a quality of assessment system.

14. The system of claim 11, further comprising a database that stores test results that cross-correlate with representative mean opinion scores obtained from subjective testing of the VQA tool.

15. A computer-implemented test method, comprising:
generating degradation data that emulates multiple video impairments of a video signal that occur due to video signal processing and video signal distribution; and
applying the degradation data to a VQA tool and generating a test score that quantifies performance of the VQA tool related to the multiple impairments.

16. The method of claim 15, wherein the video impairments are deterministic impairments that mimic effects of video compression and lossy delivery networks.

17. The method of claim 15, further comprising exercising and quantifying an active VQA tool or a passive quality of assessment system based on the degradation data.

18. The method of claim 15, further comprising generating a database that cross-correlates results with representative mean opinion scores.

19. The method of claim 15, further comprising generating a reference content database for benchmarking quality of assessment systems.

20. The method of claim 15, further comprising calibrating a passive quality of assessment system during an IP-based session.
